(19) United States
(12) Patent Application Publication
(10) Pub. No.: US 2020/0072302 A1
(43) Pub. Date: Mar. 5, 2020

(54) BRAKE COMPONENT MOUNTING STRUCTURE FOR AXLES

(71) Applicant: Hendrickson USA, L.L.C., Itasca, IL (US)

(72) Inventors: Michael D. Oyster, Stow, OH (US); Dane Gregg, Uniontown, OH (US); Steve Lehmann, Seville, OH (US); Phillippi R. Pierce, Canton, OH (US)

(21) Appl. No.: 16/536,382

(22) Filed: Aug. 9, 2019

Related U.S. Application Data
(60) Provisional application No. 62/726,621, filed on Sep. 4, 2018.

(51) Int. Cl. F16D 51/22; F16D 65/28; F16M 13/02

(52) U.S. Cl. CPC F16D 51/22; F16D 65/28; F16D 2131/00; F16D 2200/0021; F16D 2250/0023; F16M 13/02

(57) ABSTRACT

A brake component mounting structure for a thin-wall axle of a heavy-duty vehicle including a mounting plate and a brake component bracket. The brake component bracket is attached to and extends from the mounting plate. The mounting plate has at least one continuous edge attached by a continuous weld to the axle.

### CROSS-REFERENCE TO RELATED APPLICATION

This application claims the benefit of U.S. Provisional Patent Application No. 62/726,621, filed Sep. 4, 2018.

### BACKGROUND OF THE INVENTION

### Field of the Invention

The present invention relates generally to the art of axle/suspension and braking systems for heavy-duty vehicles. In particular, the present invention is directed to structures for mounting braking system components on axle/suspension systems of heavy-duty vehicles. More particularly, the present invention relates to brake system component mounting structures attached by continuous welds to thin-wall axles of heavy-duty vehicle axle/suspension systems that are relatively light-weight, reduce or eliminate stress risers, and prevent fretting.

### Background Art

The use of axle/suspension systems in the heavy-duty vehicle industry is well-known. For the purposes of clarity and convenience, reference is made to a heavy-duty vehicle with the understanding that such reference includes trucks, tractor-trailers or semi-trailers, trailers, and the like. Although axle/suspension systems, such as air-ride type and mechanical spring type axle suspension systems, can be found in widely varying structural forms, in general their structure is similar in that each system typically includes a pair of transversely-spaced mirror-image suspension assemblies. The suspension assemblies are typically connected directly to a primary frame of the heavy-duty vehicle or a subframe supported by the primary frame. For those heavy-duty vehicles that support a subframe, the subframe can be non-movable or movable, the latter being commonly referred to as a slider box, slider subframe, slider undercarriage, secondary slider frame, or bogey. For the purposes of clarity and convenience, reference is made to a frame with the understanding that such reference includes primary frames, movable subframes, and non-movable subframes.

Axle suspension systems typically include an axle extending between and connected by some means to the pair of suspension assemblies. An air spring or its equivalent and/or a shock absorber are operatively connected to the frame of a heavy-duty vehicle and each of the suspension assemblies. In addition, it is often desirable to incorporate a disc or drum braking system into the axle/suspension system to assist in heavy-duty vehicle braking. Conventional heavy-duty vehicle braking systems typically include a brake assembly for each suspension assembly and its associated wheel. Drum brake assembly components typically include a brake air chamber, a pushrod, a slack adjuster, and an S-cam assembly. The S-cam assembly includes a cam shaft and an S-cam, which moves a pair of brake shoes against a brake drum of the heavy-duty vehicle wheel to slow or stop the heavy-duty vehicle. The braking system is typically attached to the axle and supported by prior art brake component mounting structures.

Prior art drum brake component mounting structures generally include a cam shaft bracket and a brake chamber bracket. The cam shaft bracket typically supports the cam shaft inboard end, while the outboard end of the cam shaft is supported by a brake spider. The brake spider and the cam shaft bracket each support a bearing to enable rotation of the cam shaft during operation of the heavy-duty vehicle. Generally, the prior art cam shaft bracket is attached directly to the axle by line welds to provide stability to the inboard end of the cam shaft, the cam shaft bearing, and, in turn, to the entire brake assembly. The brake chamber bracket is also typically attached directly to the axle by line welds and supports the brake air chamber.

The axle/suspension system of the heavy-duty vehicle acts to stabilize the heavy-duty vehicle and locate or fix the position of the axle. More particularly, as the heavy-duty vehicle is traveling over-the-road, the wheels encounter road conditions that impart various forces, loads, and/or stresses, collectively referred to herein as forces, to the axle on which the wheels are mounted, and in turn, to the suspension assemblies that are connected to and support the axle. Such forces include vertical forces caused by vertical movement of the wheels as they encounter certain road conditions, fore-aft forces caused by acceleration and deceleration of the heavy-duty vehicle and certain road conditions, and side-load and torsional forces associated with heavy-duty vehicle transverse movement, such as turning and lane-change maneuvers. In order to minimize the detrimental effect of these forces on the axle and other heavy-duty vehicle components during operation, the axle/suspension system is designed to absorb and/or dampen at least some of the forces.

The prior art brake component mounting structures act to stabilize the braking system on the axle and react forces acting on the axle and generated by the braking system components to prevent separation of the braking system components from the axle. In particular, when an operator of the heavy-duty vehicle applies the brakes, a force is generated that creates moments and torque on the prior art brake component mounting structures. The prior art brake component mounting structures react the moments and torque to prevent peeling of the brake component mounting structures radially outward and away from the axle.

The prior art brake component mounting structures, while adequately stabilizing the braking system, have potential disadvantages, drawbacks, and limitations. For example, many prior art brake air chamber brackets and cam shaft brackets are welded directly to the axle utilizing line welds. Line welds begin at one point and terminate at a separate point, causing local changes to the mechanical properties of the axle and forming areas susceptible to stress, known as stress risers, about the beginning and termination points of the welds. These stress risers and local mechanical property changes create areas of the axle that are generally weaker, potentially reducing the durability and service life of the axle and prior art brake component mounting structures.

Thick-wall axles have been used to mitigate the potential disadvantages, drawbacks, and limitations of prior art brake component mounting structures. In particular, because axle tubes of such axles are generally thicker than those of thin-wall axles, stress risers and local mechanical property changes have a reduced impact on the durability and service life of the axles and prior art brake component mounting structures. However, the increased thickness of the axle tubes of thick-wall axles undesirably increases the weight, amount of material, and cost of manufacturing of the axle/suspension system. Moreover, the increased weight of the axle/suspension system reduces the amount of payload the heavy-duty vehicle can transport.

Prior art brake component mounting structures have also utilized peened line welds for attachment to thin-wall axles. Peened line welds are typically created as a cold work process by working the surface of the axle tube and the line weld between the axle and prior art brake component mounting structures with suitable mechanical means, such as hammer blows or shot-blasting. This process expands the surface of the cold metal of the line weld, axle, and prior art brake component mounting structures, inducing compressive stresses and/or relieving tensile stresses present therein. More particularly, the peened line welds become plastically deformed, thereby inducing a residual compressive stress state in the surfaces of the line weld and surrounding prior art brake component mounting structures and axle. The compressive surface stresses reduce and/or eliminate propagation of cracks along the line welds, prior art brake component mounting structures, and axle, thereby allowing the use of thin-wall axles, providing fatigue resistance, and improving the durability of the prior art brake component mounting structures.

Prior art brake component mounting structures with peened line welds, while adequately stabilizing the braking system, also have potential disadvantages, drawbacks, and limitations. For example, creating the peened line welds is a cold work process that it is labor intensive, as described above. As a result, utilizing peened line welds to attach prior art brake component mounting structures to the axle increases the amount of time and cost of manufacturing of the axle/suspension system.

Prior art axle wraps or sleeves with brake air chamber and cam shaft brackets have also been utilized with thin-wall axles. Prior art axle wraps are typically formed as a semi-circular or circular band of metal disposed partially or completely about the axle and have brake air chamber and cam shaft brackets formed or mounted thereon. Prior art axle wraps are also formed with one or more large openings or windows with continuous edges. The continuous edges of the windows allow for the utilization of window welds to rigidly attach the axle wraps to the axle. In particular, window welds are formed along the interface or junction between the continuous edges of the windows and the axle. Window welds are continuous welds that begin and terminate at the same point within the windows formed in the axle wrap. Because continuous window welds do not have separate beginning and termination points, stress risers are generally reduced and/or eliminated. As a result, continuous window welds are typically stronger than line welds, enabling the use of thin-wall axles.

Prior art axle wraps with brake air chamber and cam shaft brackets, while adequately stabilizing the braking system, have potential disadvantages, drawbacks, and limitations. For example, prior art axle wraps are typically large components that undesirably increase the weight, amount of material, and cost of manufacturing of the axle/suspension system. As a result, the amount of payload the heavy-duty vehicle can transport is reduced. Moreover, the continuous window welds utilized to attach prior art axle wraps to the axle do not seal the perimeter of the axle wraps. As a result, water and/or corroding agents may infiltrate between the surfaces of the prior art axle wrap and the axle, which can potentially cause fretting, thereby reducing the fatigue strength and durability of the axle and prior art axle wrap.

Thus, a need exists for a brake component mounting structure for the axle of an axle/suspension system that overcomes the disadvantages, drawbacks, and limitations of the prior art that is relatively lighter and more cost-effective, enables use of thin-wall axles, reduces and/or eliminates stress risers, and prevents fretting.

### SUMMARY OF THE INVENTION

Objectives of the present invention include providing a structure for mounting brake component brackets that reduces or eliminates stress risers formed when attached to a thin-wall axle of a heavy-duty vehicle.

A further objective of the present invention includes providing a structure for mounting brake component brackets that prevents water and corroding agents from causing fretting between the mounting structures and the axle.

Yet another objective of the present invention includes providing a structure for mounting brake component brackets that is relatively lighter and more cost-effective in order to increase the amount of payload of the heavy-duty vehicle.

These objectives and advantages are obtained by the brake component mounting structure for an axle of a heavy-duty vehicle including a mounting plate and a brake component bracket. The brake component bracket is attached to and extends from the mounting plate. The mounting plate is attached to the axle by a continuous weld formed about at least one continuous edge of the mounting plate.

The objectives and advantages are also obtained by the brake component mounting structure for an axle of a heavy-duty vehicle having a first mounting plate, a second mounting plate, and a brake component bracket. The first mounting plate has at least one continuous edge. The second mounting plate has at least one continuous edge and is spaced a circumferential distance about the axle from the first mounting plate. The brake component bracket is attached to and extends between the first mounting plate and the second mounting plate. The first and second mounting plates are each attached to the axle by at least one continuous weld at an interface between the axle and the continuous edges.

### BRIEF DESCRIPTION OF THE SEVERAL VIEWS OF THE DRAWINGS

The preferred embodiments of the present invention, illustrative of the best mode in which applicants have contemplated applying the principles, are set forth in the following description, shown in the drawings, and particularly and distinctly pointed out and set forth in the appended claims.

FIG. 1 is a prior art driver-side rear perspective view, partially in phantom, of a heavy-duty vehicle axle/suspension system utilizing prior art brake component mounting structures attached to the axle by untreated line welds;

FIG. 2 is an enlarged fragmentary rear perspective view of another prior art brake component mounting structure for a heavy-duty vehicle axle/suspension system attached to a thin-wall axle by peened line welds;

FIG. 3 is a front perspective view of an axle of a heavy-duty vehicle axle/suspension system in a cams-rearward configuration incorporating a prior art axle wrap with brake component brackets attached to the axle by window welds;

FIG. 4 is a bottom rear perspective view of the axle shown in FIG. 3;

FIG. 5 is bottom rear perspective view of a thin-wall axle incorporating first exemplary embodiment brake component mounting structures of the present invention;

FIG. 6 is another similar perspective view of the thin-wall axle with first exemplary embodiment brake component mounting structures shown in FIG. 5;

FIG. 7 is an enlarged perspective view of the first exemplary embodiment brake component mounting structure shown in FIGS. 5-6, incorporating a brake air chamber bracket;

FIG. 8 is an enlarged perspective view of the first exemplary embodiment brake component mounting structure shown in FIGS. 5-6, incorporating a cam shaft bracket;

FIG. 9 is an elevational view, partially in phantom, of the first exemplary embodiment brake component mounting structures, shown in FIGS. 5-8, attached to the thin-wall axle;

FIG. 10 is a fragmentary perspective view, partially in phantom, of the first exemplary embodiment brake component mounting structures, shown in FIGS. 5-9, attached to the thin-wall axle;

FIG. 11 is a bottom perspective view of a thin-wall axle incorporating second exemplary embodiment brake component mounting structures of the present invention;

FIG. 12 is another perspective view of the thin-wall axle with second exemplary embodiment brake component mounting structures shown in FIG. 11;

FIG. 13 is an elevational view, partially in phantom, of the second exemplary embodiment brake component mounting structures, shown in FIGS. 11-12, attached to a thin-wall axle;

FIG. 14 is an enlarged perspective view of the second exemplary embodiment brake component mounting structure, shown in FIGS. 11-13, incorporating a brake air chamber bracket;

FIG. 15 is an enlarged perspective view of the second exemplary embodiment brake component mounting structure shown in FIGS. 11-13, incorporating a cam shaft bracket;

FIG. 16 is a bottom perspective view of a thin-wall axle incorporating third exemplary embodiment brake component mounting structures of the present invention;

FIG. 17 is another perspective view of the thin-wall axle with third exemplary embodiment brake component mounting structures shown in FIG. 16;

FIG. 18 is an elevational view, partially in phantom, of the third exemplary embodiment brake component mounting structures, shown in FIGS. 16-17 attached to the thin-wall axle;

FIG. 19 is an enlarged perspective view of the third exemplary embodiment brake component mounting structure shown in FIGS. 16-18, incorporating a brake air chamber bracket;

FIG. 20 is an enlarged perspective view of the third exemplary embodiment brake component mounting structure shown in FIGS. 16-18, incorporating a cam shaft bracket;

FIG. 21 is a bottom perspective view of a thin-wall axle incorporating fourth exemplary embodiment brake component mounting structures of the present invention;

FIG. 22 is another perspective view of the thin-wall axle with fourth exemplary embodiment brake component mounting structures shown in FIG. 21;

FIG. 23 is an elevational view, partially in phantom, of the fourth exemplary embodiment brake component mounting structures, shown in FIGS. 21-22, attached to the thin-wall axle;

FIG. 24 is an enlarged perspective view of the fourth exemplary embodiment brake component mounting structures shown in FIGS. 21-23;

FIG. 25 is an elevational view, partially in phantom, of fifth exemplary embodiment brake component mounting structures, shown attached to a thin-wall axle; and

FIG. 26 is an enlarged perspective view of the fifth exemplary embodiment brake component mounting structures shown in FIG. 25.

Similar reference characters identify similar parts throughout.

### DESCRIPTION OF THE PREFERRED EMBODIMENT

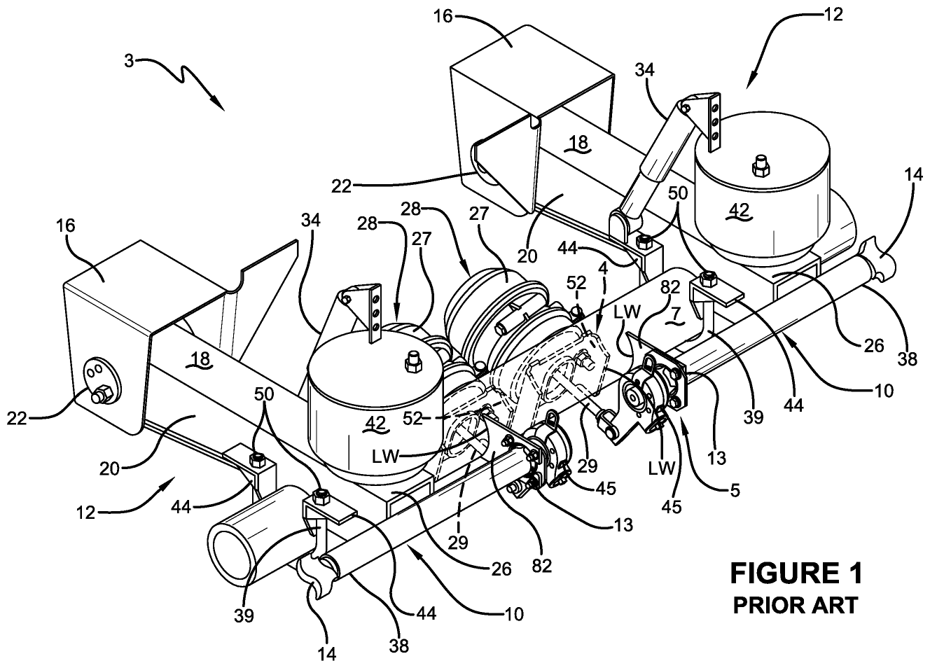

In order to better understand the brake component mounting structure for axles of heavy-duty vehicle axle/suspension systems of the present invention, a heavy-duty vehicle axle/suspension system 3 utilizing prior art brake component mounting structures 4, 5 is shown in FIG. 1 and will now be described. Axle/suspension system 3 includes a pair of mirror-image prior art suspension assemblies 12. Because prior art suspension assemblies 12 are generally mirror-images of one another, and for sake of clarity and convenience, only one of the suspension assemblies will be described.

Prior art suspension assembly 12 includes a beam 18 pivotally connected to a hanger 16, which is attached to a frame (not shown) of a heavy-duty vehicle (not shown). More specifically, beam 18 includes a front end 20 having a bushing assembly 22 to facilitate pivotal connection of the front end of the beam to hanger 16, as is known. Beam 18 also includes a rear end 26, which is rigidly attached to a transversely-extending hollow axle 7. Axle 7 has a standard wall thickness in the range of from about 0.42 inches to about 1.0 inches, as is known. Axle 7 is typically attached to beam rear end 26 in a known manner, such as by a pair of U-bolts 39 disposed about the axle and fastened by nuts 50 to U-bolt brackets 44, which in turn are attached to beam 18. An air spring 42 is mounted on and extends between rear end 26 of beam 18 and the frame of the heavy-duty vehicle. A shock absorber 34 may also be mounted on and extend between beam 18 and the frame, as is known.

Suspension assembly 12 also typically has a respective brake assembly 28 mounted thereon. Brake assembly 28 includes a cam shaft assembly 10. Cam shaft assembly 10 includes an S-cam 14 attached to an outboard end of a transversely extending cam shaft (not shown), which may be disposed within a cam shaft tube 38, as is known, and is supported at the outboard end by a brake spider (not shown) and a bearing (not shown). The inboard end of the cam shaft is supported by prior art brake component mounting structure 5. Prior art brake component mounting structure 5 includes a cam shaft bracket 82 having a cam support bushing assembly 13. The cam shaft is rotatably mounted in the brake spider bearing and the cam support bushing assembly 13, allowing the cam shaft to rotate and move a pair of brake shoes (not shown) against a brake drum (not shown) of a wheel (not shown) to slow or stop the heavy-duty vehicle during operation. Cam shaft bracket 82 is attached directly to axle 7 via untreated line welds LW. Prior art cam shaft bracket 82 provides stability to the inboard end of cam shaft assembly 10, which, in turn, provides stability to brake assembly 28 and reacts thrust forces from a piston rod 29.

Brake assembly 28 also includes a slack adjuster 45. Slack adjuster 45 is operatively connected to the inboard end of cam shaft assembly 10. Piston rod 29 extends between and is operatively connected to slack adjuster 45 and a brake air chamber 27. Brake air chamber 27 is supported by prior art brake component mounting structure 4. Prior art brake component mounting structure 4 includes a brake chamber bracket 52. Prior art brake chamber bracket 52 is attached to axle 7 by untreated line welds LW. Prior art brake chamber bracket 52 reacts thrust forces from piston rod 29 transmitted through brake air chamber 27 and reacts vertical forces created by the vibration of the brake air chamber.

Prior art brake component mounting structures 4, 5, while providing stability to brake assembly 28, have potential disadvantages, drawbacks, and limitations. For example, the attachment of brake chamber bracket 52 and cam shaft bracket 82 directly to axle 7 by untreated line welds LW can potentially create significant stress risers and local mechanical property changes in the axle, as is known. Such stress risers and local mechanical property changes can potentially reduce the durability and service life of axle 7, such that use of thick-wall axles, such as axle 7, is typically required to counteract the effects of the stress risers. However, axle 7 adds undesirable weight to axle/suspension system 3, reducing the amount of payload the heavy-duty vehicle can transport.

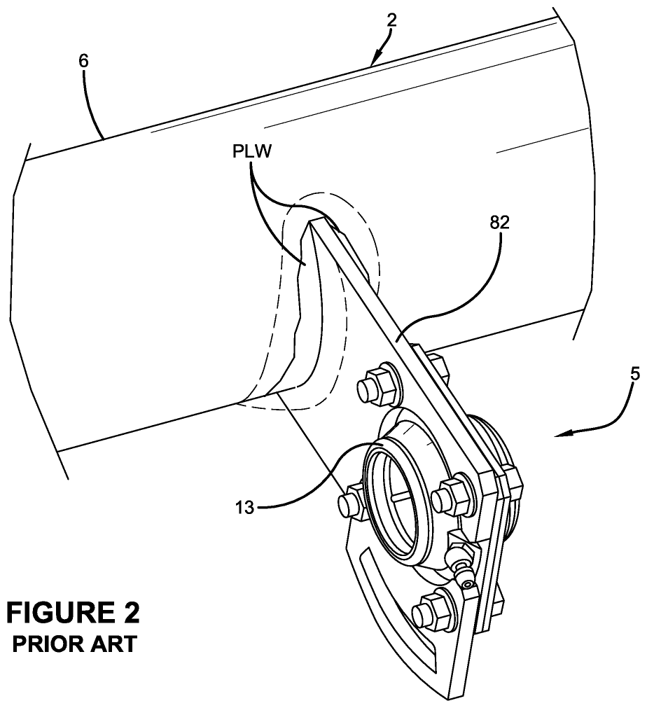

Alternatively, and with additional reference to FIG. 2, prior art brake component mounting structure 5 may be incorporated onto a thin-wall axle 2 using peened line welds PLW. Prior art brake component mounting structure 4 may be incorporated onto axle 2 in a similar manner, as is known. Axle 2 is similar in construction and arrangement to axle 7, except that it includes an axle tube 6 with a relatively thin wall, as is known. Moreover, axle 2 may be incorporated into any axle/suspension system, such as axle/suspension system 3, described above. Prior art brake component mounting structure 5 is attached to axle tube 6 of axle 2 by peened line welds PLW, which extend along each of the inboard and outboard surfaces of cam shaft bracket 82.

Peened line welds PLW are formed generally adjacent to the rear quadrant of axle 2 at the interface of cam shaft bracket 82 and the axle. Peened line weld PLW has separate starting and termination points on each side of cam shaft bracket 82 and is peened along its entire length to improve its strength. In addition, the peening extends a distance beyond the weld-to-axle interface and the boundary of where stress concentrations exist in order to increase desirable compressive stresses.

Prior art brake component mounting structures 4, 5 with peened line welds PLW, while providing stability to the braking assembly, has potential disadvantages, drawbacks, and limitations. For example, peened line weld PLW is formed using a cold work process that is labor intensive. As a result, prior art brake component mounting structures 4, 5 with peened line welds PLW undesirably increase the amount of time and cost of manufacturing of the heavy-duty vehicle axle/suspension system 3.

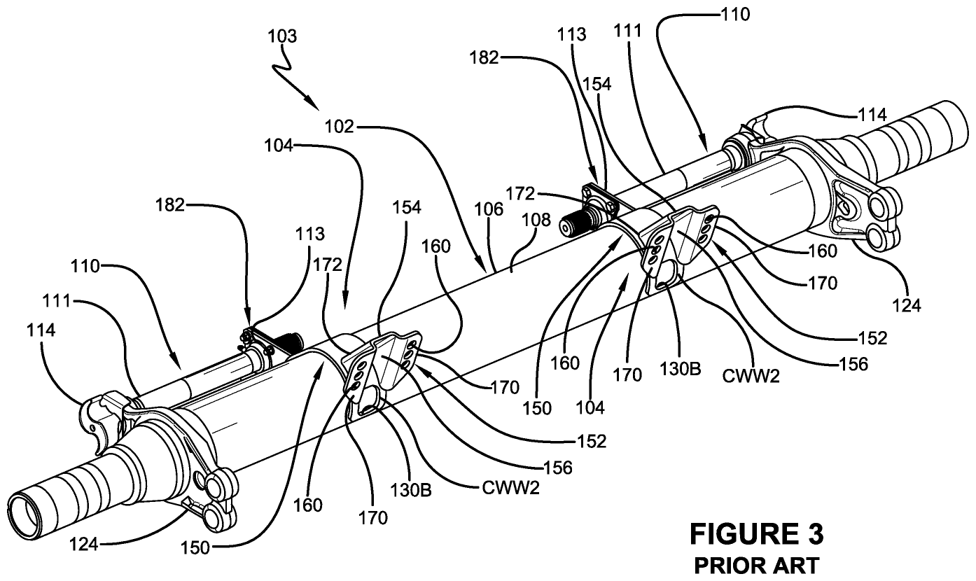

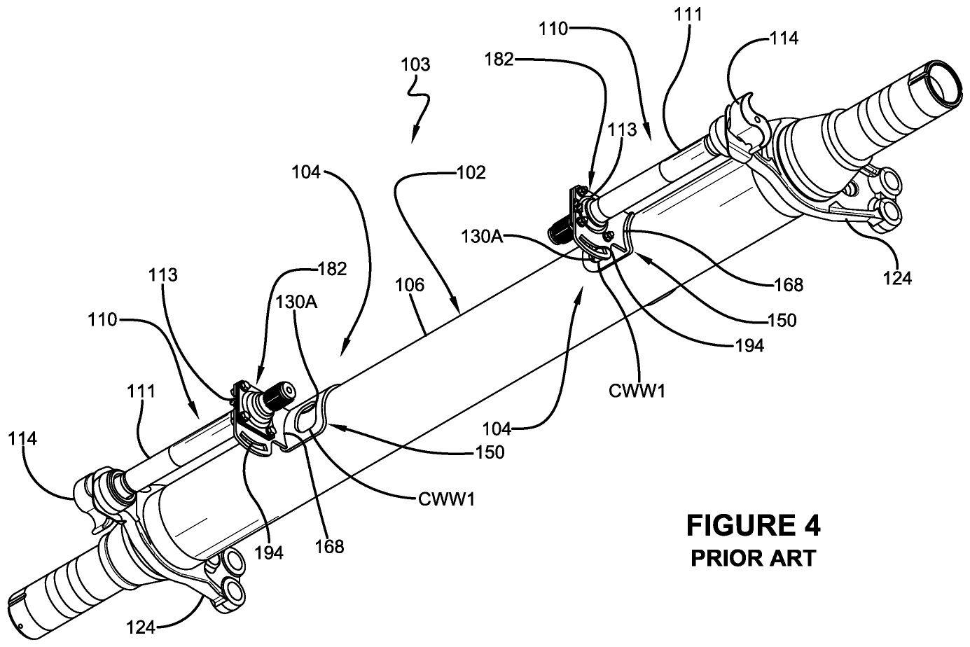

Another pair of prior art brake component mounting structures 104 is illustrated in FIGS. 3-4 connected to a thin-wall axle 102 of an axle suspension system 103 (partially shown). Axle/suspension system 103 may be any type of axle/suspension system, such as axle/suspension system 3, described above. Axle 102 is similar in construction and arrangement to axle 2, described above, and includes an axle tube 106. Because brake component mounting structures 104 are generally identical, and for the sake of clarity and convenience, only a single brake component mounting structure will be described below.

Brake component mounting structure 104 includes a generally C-shaped axle wrap portion 150. Axle wrap portion 150 partially surrounds axle 102. In particular, axle wrap portion 150 is formed with a curvature that is complementarily-shaped to a top portion 108 of the axle and is seated thereon. More particularly, axle wrap portion 150 surrounds axle 102 in a range from about 180 degrees to about 360 degrees. The range of partial to complete surroundment of axle 102 by axle wrap portion 150 allows for the axle wrap portion to pull apart from and snap onto the axle, or slide onto the axle if the wrap completely surrounds the axle, providing a generally gap-free close-contact connection.

Brake component mounting structure 104 also includes a generally C-shaped planar cam shaft bracket 182, similar in construction and arrangement to cam shaft bracket 82, described above, with a cam support bushing assembly 113 of a cam shaft assembly 110 operatively connected thereto. An inboard end of a cam shaft 111 is rotatably mounted in cam support bushing assembly 113, allowing the cam shaft to rotate parallel to axle 102. An S-cam 114 is exposed and attached to an outboard end of cam shaft 111. A brake spider 124 is immovably mounted, such as by welding, on axle 102 and supports the outboard end of cam shaft 111. Cam shaft bracket 182 is formed with a curved elongated opening 194 (FIG. 4) to receive an anchor pin (not shown). Cam shaft bracket 182 is rigidly connected to axle wrap portion 150 by any suitable means, such as welds, at an interface 168 between a curved surface of the cam shaft bracket and a complementarily-curved exterior surface of the axle wrap portion.

Brake component mounting structure 104 also includes a brake air chamber bracket 152. Brake air chamber bracket 152 has a generally U-shaped cross-section with a pair of sidewalls 156 and a base 154. Sidewalls 156 include a pair of flanges or wings 170 that each extend perpendicularly from the respective sidewall and are spaced from base portion 154. Each wing 170 is formed with a plurality of openings 160 to facilitate connection of a brake air chamber (not shown) to each brake chamber bracket 152. Brake chamber bracket 152 is attached to axle wrap portion 150 at interface 172 using any suitable method, such as welding.

Prior art axle wrap portion 150 is typically attached to axle 102 by welding. Specifically, prior art axle wrap portion 150 is formed with a pair of windows 130A, B that are generally similar in size and facilitate the rigid attachment of axle wrap portion 150 to axle 102. Axle wrap portion 150 is disposed about axle 102, such that windows 130A, B are over or adjacent the horizontal neutral axis of the axle. A continuous window weld CWW1, 2 is disposed in each of windows 130A, B, respectively. Continuous window welds CWW1, 2 start and terminate at the same point within the respective window 130A, B. As a result continuous window welds CWW1, 2 reduce or eliminate stress risers in axle 102. Moreover, continuous window welds CWW1, 2 are located on the axle in an area generally considered to be a lower stress area, namely the front and rear quadrants, or near the horizontal neutral axis, of the axle. Thus, continuous window welds CWW1, 2 within windows 130A, B, respectively, and the respective locations of the continuous window welds relative to axle 102 reduce the possibility of stress risers and facilitate the use of the thin-wall axle.

Brake component mounting structure 104, while adequately stabilizing the braking system, has potential disadvantages, drawbacks, and limitations. For example, axle wrap portion 150 of brake component mounting structure 104 undesirably increases the weight, the amount of material, and the cost of manufacturing of the axle/suspension system, thereby reducing the amount of payload the heavy-duty vehicle can transport. In addition, axle wrap portion 150 has a large amount of surface in close contact with axle 102. Continuous window welds CWW1, 2 secure axle wrap portion 150 to axle 102 but do not seal the perimeter of the axle wrap portion. As a result, water and corroding agents can potentially infiltrate between the axle wrap portion 150 and axle 102 leading to fretting, which can reduce the fatigue strength, durability, and service life of brake component mounting structure 104 and the axle.

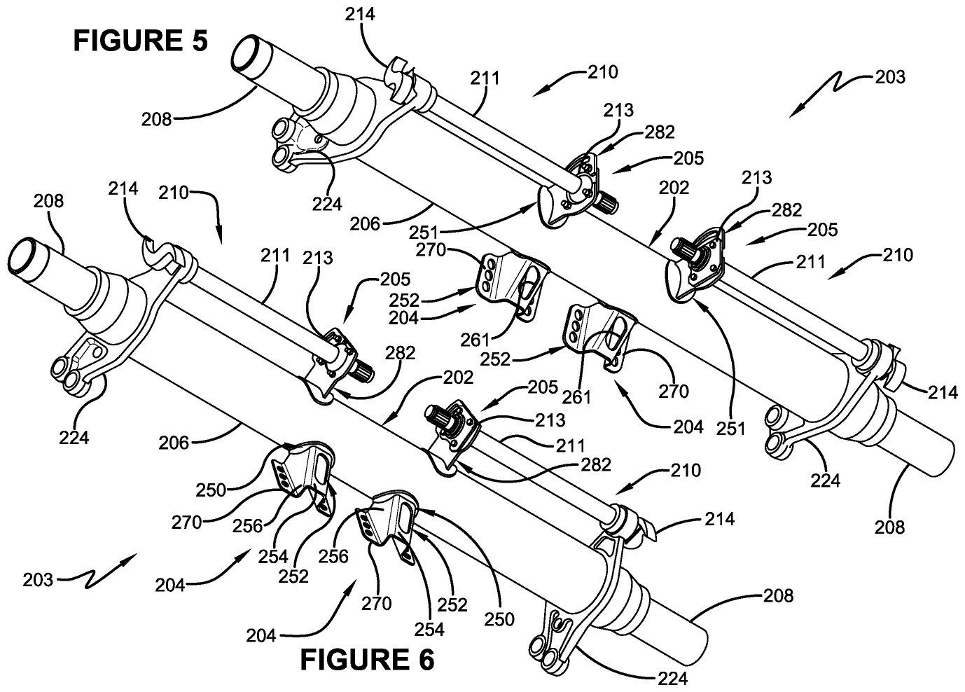

First exemplary embodiment brake component mounting structures 204, 205 of the present invention are shown in FIGS. 5-6 supporting a braking system (only portions shown and described below) and will now be described. Brake component mounting structures 204, 205 may be utilized with any axle/suspension system, such as an axle/suspension system 203 (partially shown). Axle/suspension system 203 is generally similar to axle/suspension system 3 (FIG. 1) described above.

Axle/suspension system 203 includes a thin-wall axle 202 having an axle tube 206. Axle tube 206 is generally formed with a wall thickness ranging from about 0.236 inches to about 0.5 inches. More specifically, axle tube 206 has a wall thickness ranging from about 0.256 inches to about 0.381 inches. A respective axle spindle 208 is attached at axially opposite ends of axle tube 206. A pair of cam shaft assemblies 210 are operatively connected to axle 202. Each cam shaft assembly 210 includes a cam shaft 211 with an S-cam 214. The outboard end of each cam shaft 211 is mounted on a brake spider 224. The inboard end of cam shaft 211 is disposed through a cam support bushing assembly 213, which is mounted on brake component mounting structure 205. A brake air chamber (not shown) is operatively connected to a slack adjuster (not shown), which is operatively connected to the inboard end of cam shaft 211. Brake component mounting structures 204 are mounted on axle tube 206 and support respective ones of the brake air chambers.

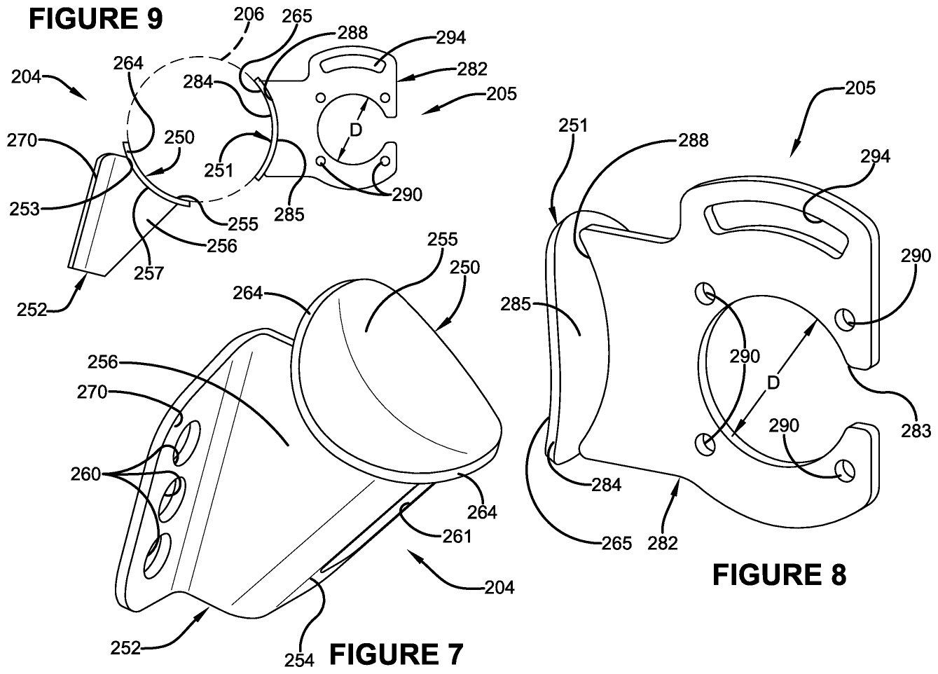

With additional reference to FIGS. 7-10, brake component mounting structures 204, 205 are formed out of any suitable rigid material, such as metal or composite, using any suitable method, such as bending. More particularly, mounting structures 204, 205 may be formed by bending a single piece of metal having a thickness in the range of from about 0.15 inches to about 0.375 inches, or, more specifically, in the range of from about 0.177 inches to about 0.236 inches. However, it is contemplated that any suitable thickness, or even variable thickness, material may be used depending on the expected maximum load mounting structures 204, 205 may encounter during heavy-duty vehicle operation. Alternatively, brake component mounting structures 204, 205 may be formed from multiple pieces and assembled or connected using any suitable method, such as welding.

In accordance with an important aspect of the present invention, brake component mounting structures 204, 205 each include an axle mounting plate 250, 251, respectively. Axle mounting plates 250, 251 may be of any suitable thickness for a particular axle, but in some cases may be approximately half the thickness or double the thickness of thin-wall axle tube 206. Axle mounting plates 250, 251 may have a thickness in the range of from about 0.15 inches to about 0.375 inches. More particularly, axle mounting plates 250, 251 may have a thickness in the range of from about 0.177 inches to 0.236 inches.

Axle mounting plates 250, 251 each have continuous perimeters with outer edges 264, 284 (FIGS. 7-8), respectively. Outer edges 264, 284 are each formed as a continuous edge with no starting point and no termination point. Outer edges 264, 284 may be formed as any suitable shape(s) that form a continuous outside edge, such as circular or ovoid. Each mounting plate 250, 251 is formed with a curvature, such that each mounting plate has a concave inner surface 255, 265 (FIGS. 7-9) and a convex outer surface 257, 285, respectively. Each concave inner surface 255, 265 is complementarily-shaped to a curvature of an outer surface of axle tube 206 to facilitate close contact between the axle tube and the axle mounting plates.

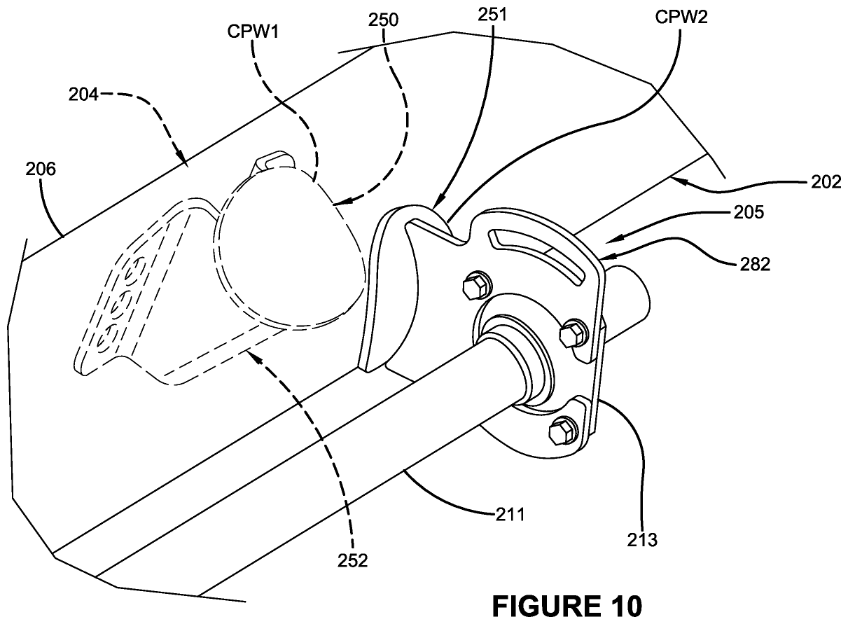

In accordance with another important aspect of the present invention, brake component mounting structures 204, 205 are attached to axle 202 by respective continuous perimeter welds CPW1, 2 (FIG. 10). In particular, the continuous nature of outside edges 264, 284 allow continuous perimeter welds CPW1, 2 to attach axle mounting plates 250, 251, respectively, to axle 202. More particularly, continuous perimeter welds CPW1, 2 each begin at a point along the respective outer edge 264, 284 of axle mounting plate 250, 251; are continuously produced around the respective outer edge; and terminate at the point at which each continuous perimeter weld was initiated. As a result, continuous perimeter weld CPW1, 2 has no gaps and lacks separate starting and termination points due to the continuity of the continuous perimeter weld and shape of outside edge 264, 284 of plate 250, 251, respectively, completely attaching the entirety of the outside edge to axle tube 206 of axle 202. Thus, continuous perimeter welds CPW1, 2 are typically stronger than, and minimize and/or eliminate stress risers typically associated with, prior art line welds, which facilitates the use of thin-wall axle 202, reducing the weight, amount of material, and cost of manufacturing of axle/suspension system 203, thereby enabling the heavy-duty vehicle to carry a greater amount of payload. In addition, continuous perimeter welds CPW1, 2 form a seal about the perimeter of the respective axle mounting plate 250, 251. As a result, infiltration of water and/or corrosive agents between brake component mounting structures 204, 205 and axle 202 is minimized or eliminated. It is also contemplated that other shapes and/or sizes of axle mounting plates 250, 251 with differently-shaped outside edges 264, 284, respectively, may be used to facilitate the desired respective continuous perimeter weld CPW1, 2.

Brake component mounting structures 204, 205 also include a brake air chamber bracket 252 and a cam shaft bracket 282, respectively, attached to axle mounting plates 250, 251. Brake chamber bracket 252 may be formed from any suitable rigid material, such as metal or composite, by any suitable method, such as bending and may have any suitable shape(s), component(s), arrangement(s), and/or feature(s). In particular, brake chamber bracket 252 is formed by bending a continuous sheet of metal. Brake chamber bracket 252 includes a base 254 and a pair of spaced-apart sidewalls 256. An opening 261 is formed in base 254 to allow passage of an air chamber piston rod (not shown), as is known. Sidewalls 256 extend perpendicular to base 254, such that brake chamber bracket 252 has a generally U-shaped cross-section. Sidewalls 256 include a pair of wings or flanges 270 that extend perpendicularly from the respective sidewall and are spaced a distance along the respective sidewall from base 254. Flanges 270 are formed with a plurality of openings 260 arranged in a manner suitable for attaching a braking system component, such as the brake air chamber, to brake chamber bracket 252, as is known. Sidewalls 256 of brake chamber bracket 252 are also formed with respective edges 253. Edges 253 are generally concave and complementarily-shaped to outer surface 257 of axle mounting plate 250. Brake chamber bracket 252 is rigidly attached to mounting plate 250 by welds applied at the interface of edges 253 and axle mounting plate outer surface 257.

Cam shaft bracket 282 may be formed from a single continuous or multiple sheets of any suitable material, such as metal or composite, and formed into any suitable shape. In particular, cam shaft bracket 282 is formed as a generally C-shaped planar structure with a circular open portion 283 having a dimension or diameter D. Diameter D is larger than an outside diameter of cam shaft 211 to allow the cam shaft to pass through open portion 283. Cam shaft bracket 282 includes a plurality of openings 290 in a circumferentially spaced arrangement about open portion 283. Openings 290 are utilized to mount an inboard end of cam bushing assembly 213 (FIGS. 5-6) to cam shaft bracket 282. Cam shaft bracket 282 may be formed with an elongated opening 294 adjacent to open portion 283 to receive an anchor pin (not shown), as is known. Cam shaft bracket 282 also includes a generally concave edge 288 opposite open portion 283 that is complementarily-shaped to outer surface 285 of axle mounting plate 251. Cam shaft bracket 282 is rigidly attached to mounting plate 251 by welds applied at the interface of edge 288 and axle mounting plate outer surface 285.

During assembly, each brake component mounting structure 204, 205 is positioned on tube 206 of axle 202. More particularly, mounting structures 204, 205 are disposed generally on or adjacent to the front and rear quadrants, or the rear and front quadrants, respectively, of axle tube 206. Each axle mounting plate 250, 251 is placed and/or held in position against axle tube 206 to allow continuous perimeter welds CPW1, 2, respectively, to be formed about the respective outside edge 264, 284 of axle mounting plate 250, 251, respectively.

Brake component mounting structure 204, 205 may be fully assembled before axle mounting plate 250, 251 is attached by continuous perimeter weld CPW1, 2, respectively, to axle 202. Alternatively, it is contemplated that each axle mounting plate 250, 251 may be rigidly attached to axle tube 206 before brake air chamber bracket 252 and cam shaft bracket 282, respectively, are attached thereto. The brake air chamber (not shown) and cam bushing assembly 213 can be subsequently attached to brake chamber bracket 252 and cam shaft bracket 282, respectively. Cam shaft 211 of cam shaft assembly 210 can then be engaged in cam bushing assembly 213.

Thus, brake component mounting structures 204, 205 of the present invention minimize and/or eliminate stress risers, facilitating the use of thin-wall axle 202 and reducing the weight, amount of material, and cost of manufacturing of axle/suspension system 203, thereby enabling the heavy-duty vehicle to carry a greater amount of payload. Brake component mounting structures 204, 205 also provide a seal about the outer edge 264, 284 of the respective axle mounting plate 250, 251, minimizing or eliminating infiltration of water and/or corrosive agents between the brake component mounting structures and axle 202, maintaining or improving the fatigue strength and durability and increasing the service life of the brake component mounting structures and the axle.

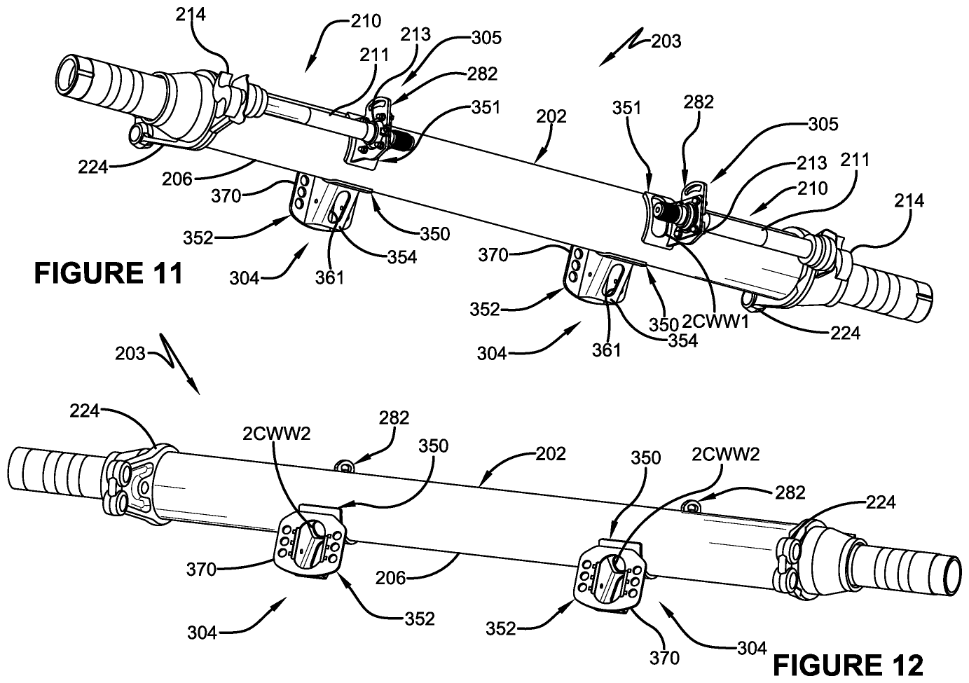

Second exemplary embodiment brake component mounting structures 304, 305 of the present invention are shown in FIGS. 11-12 incorporated into an axle/suspension system. Brake component mounting structures 304, 305 may be utilized in any axle/suspension system, such as axle/suspension system 203. Brake component mounting structures 304, 305 are similar in construction and arrangement to brake component mounting structures 204, 205 (FIGS. 7-9). As a result, the description below will be primarily directed to the differences between brake component mounting structures 204, 205 and brake component mounting structures 304, 305.

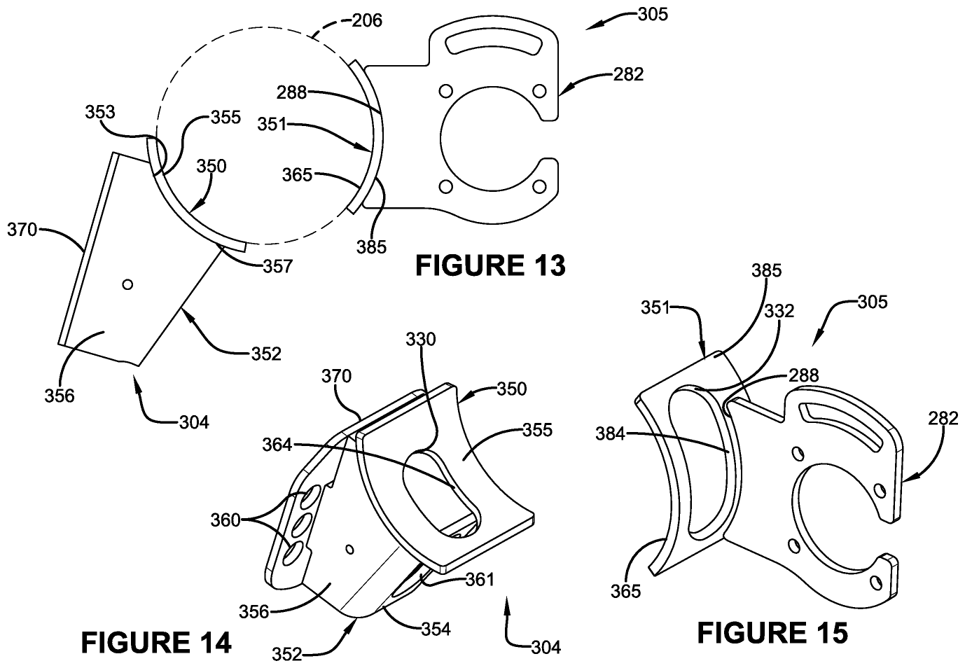

With additional reference to FIGS. 13-15, Brake component mounting structures 304, 305 may be formed from any suitable rigid material such as metal or composite, using any suitable method. In particular, brake component mounting structures 304, 305 are formed by bending a single continuous piece of metal having a thickness in the range of from about 0.15 inches to about 0.375 inches, or, more specifically, in the range of from about 0.177 inches to about 0.236 inches, into suitable shapes. However, it is contemplated that any suitable thickness, or even variable thickness, material may be used depending on the expected maximum load mounting structures 304, 305 may encounter during heavy-duty vehicle operation. Alternatively, brake component mounting structures 304, 305 may be formed from multiple pieces and assembled or connected by any suitable means, such as welds.

In accordance with an important aspect of the present invention, brake component mounting structures 304, 305 each include an axle mounting plate 350, 351, respectively. Axle mounting plates 350, 351 may be of any suitable thickness for a particular axle, but in some cases may be approximately half the thickness or double the thickness of thin-wall axle tube 206. Axle mounting plates 350, 351 may have a thickness in the range of from about 0.15 inches to about 0.375 inches. More specifically axle mounting plates may have a thickness in the range of from about 0.177 inches to about 0.236 inches.

Axle mounting plates 350, 351 are formed with a curvature, such that each axle mounting plate has a respective concave inner surface 355, 365 and a convex outer surface 357, 385. Inner surfaces 355, 365 are complementarily-shaped to the curvature of the outside surface of axle tube 206, thereby facilitating close contact between axle mounting plates 350, 351 and the axle tube. A window 330, 332 is formed in and passes through axle mounting plate 350, 351, respectively. Specifically, each window 330, 332 is defined by a continuous elongated circular, obround, oblong, or oval-shaped continuous inner edge 364, 384. It is contemplated that windows 330, 332 may be formed with any suitable shape(s) that has a continuous edge.

In accordance with another important aspect of the present invention, brake component mounting structures 304, 305 are attached to axle 202 by respective continuous window welds 2CWW2, 1 (FIGS. 11-12). In particular, the continuous nature of inner edges 364, 384 of windows 330, 332, respectively, allow continuous window weld 2CWW2, 1 to attach axle mounting plates 350, 351, respectively, to axle 202. More particularly, continuous window welds 2CWW2, 1 each begin at a point along the respective inner edge 364, 384 of window 330, 332; are continuously produced around the respective inner edge; and terminate at the point at which each continuous window weld was initiated. As a result, continuous window weld 2CWW2, 1 has no gaps and lacks separate starting and termination points due to the continuous nature and shape of inner edge 364, 384, respectively, completely attaching the entirety of the inner edge to axle tube 206 of axle 202. Thus, continuous window welds 2CWW1, 2 are typically stronger than, and minimize and/or eliminate stress risers associated with, prior art line welds. Continuous window welds 2CWW1, 2 facilitate the use of thin-wall axle 202, reducing the weight and amount of material and cost of manufacturing axle/suspension system 203, thereby enabling the heavy-duty vehicle to carry a greater amount of payload. It is also contemplated that other shape and/or size of axle mounting plates 350, 351 with differently shaped windows 330, 332 and with inner edges 364, 384, respectively, may be used to facilitate the desired respective continuous window weld 2CWW2, 1.

Brake component mounting structures 304, 305 also include a brake air chamber bracket 352 and a cam shaft bracket 282 attached to axle mounting plates 350, 351, respectively. Brake chamber bracket 352 is similar in construction and arrangement to brake air chamber bracket 252, described above. Moreover, brake component mounting structure 304 may include either brake chamber bracket 252, 352. Brake chamber bracket 352 may be formed from any suitable rigid material, such as metal or composite, by any suitable method, such as bending and may have any suitable shape(s), component(s), arrangement(s), and/or feature(s). In particular, brake chamber bracket 352 is formed by bending a continuous sheet of metal. Brake chamber bracket 352 includes a base 354 and a pair of spaced-apart sidewalls 356. An opening 361 is formed in base 354 to allow passage of an air chamber piston rod (not shown). Sidewalls 356 extend perpendicularly from base 354, such that brake chamber bracket 352 has a generally U-shaped cross-section. A chamber mounting plate 370 is attached to, by any suitable means, such as welds, and extends perpendicularly from sidewalls 356 and is spaced a distance along the sidewalls from base 354. Chamber mounting plate 370 is formed with a plurality of openings 360 arranged in a manner suitable for attaching a braking system component, such as a brake air chamber (not shown), to brake chamber bracket 352, as is known. Sidewalls 356 of brake chamber bracket 352 are also formed with respective edges 353. Edges 353 are generally concave and complementarily-shaped to convex outer surface 357 of axle mounting plate 350. Brake chamber bracket 352 is rigidly attached to mounting plate 350 by welds formed along the interface of edges 353 and axle mounting plate outer surface 357 adjacent to window 330.

Cam shaft bracket 282, as described above, includes a generally concave edge 288. Concave edge 288 is complementarily-shaped to outer surface 385 of axle mounting plate 351. Cam shaft bracket 282 is generally disposed laterally of window 332 and attached to mounting plate 351 by welds applied at the interface of edge 288 and axle mounting plate outer surface 385.

During assembly, each mounting plate 350, 351 is positioned on tube 206 of axle 202. More particularly, mounting plates 350, 351 are disposed generally on, or adjacent to, the front and rear quadrants, or the rear and front quadrants, respectively, of axle tube 206. Each axle mounting plate 350, 351 is placed and/or held against axle tube 206 in position to allow continuous window welds 2CWW2, 1 to be formed about the respective inner edge 364, 384 of window 330, 332. Brake chamber bracket 352 and cam shaft bracket 282 are then welded to the respective mounting plate 350, 351. Alternatively, brake component mounting structure 305 may be fully assembled before mounting plate 351 is attached to axle 202 by continuous window weld 2CWW1.

Thus, brake component mounting structures 304, 305 of the present invention minimize and/or eliminate stress risers, facilitating the use of thin-wall axle 202 and reducing the weight, amount of material, and cost of manufacturing of axle/suspension system 203, thereby enabling the heavy-duty vehicle to carry a greater amount of payload.

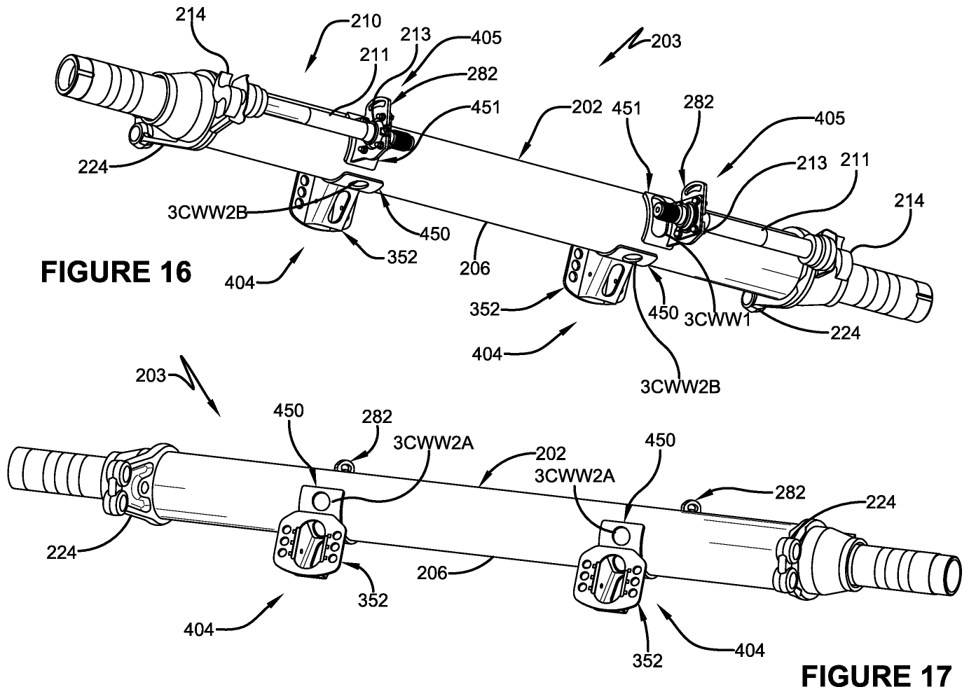

Third exemplary embodiment brake component mounting structures 404, 405 of the present invention are shown in FIGS. 16-17 incorporated into an axle/suspension system. Brake component mounting structures 404, 405 may be utilized in any axle/suspension system, such as axle/suspension system 203 (partially shown). Brake component mounting structures 404, 405 are similar in construction and arrangement to brake component mounting structures 204, 205 (FIGS. 5-10) and brake component mounting structures 304, 305 (FIGS. 11-15). As a result, the description below will be primarily directed to the differences between brake component mounting structures 204, 205, 304, 305 and brake component mounting structures 404, 405.

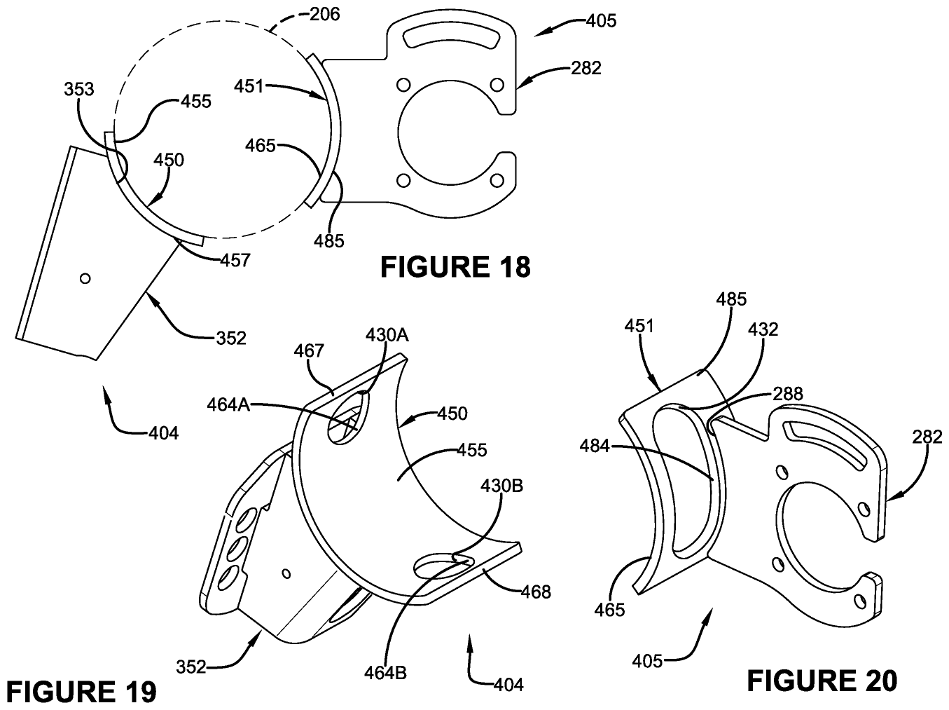

With additional reference to FIGS. 18-20, brake component mounting structures 404, 405 may be formed from any suitable rigid material such as metal or composite, using any suitable method. Brake component mounting structures 404, 405 may have any suitable thickness for a particular axle, but in some cases may be approximately half the thickness or double the thickness of thin-wall axle tube 206. In particular, brake component mounting structures 404, 405 are formed by bending a single piece of metal having a thickness in the range of from about 0.15 inches to about 0.375 inches, or, more specifically, in the range of from about 0.177 inches to about 0.236 inches, into suitable shapes. However, it is contemplated that any suitable thickness, or even variable thickness, material may be used depending on the expected maximum load mounting structures 404, 405 may encounter during heavy-duty vehicle operation. Alternatively, brake component mounting structures 404, 405 may be formed from multiple pieces and assembled or connected by any suitable means, such as welding.

In accordance with an important feature of the present invention, brake component mounting structures 404, 405 each include an axle mounting plate 450, 451. Axle mounting plates 450, 451 are formed with a curvature, such that each axle mounting plate has a respective concave inner surface 455, 465 and convex outer surface 457, 485. Inner surfaces 455, 465 are complementarily-shaped to the curvature of the outside surface of axle tube 206, thereby facilitating close contact between axle mounting plates 450, 451 and axle 202. Axle mounting plates 450, 451 are each formed with respective windows 430A, B and 432. Window 432 is formed in and passes through mounting plate 451 and has an elongated circular, obround, oblong, or oval shape. Windows 430A, B are formed in and pass through axle mounting plate 450 and have a generally circular shape. More particularly, windows 430A, B are arranged near or adjacent to opposite edges 467, 468 of axle mounting plate 450. Each window 430A, 430B, 432 is defined by a continuous inner edge 464A, 464B, 484, respectively, having continuous curves lacking corners. It is also contemplated that windows 430A, 430B, 432 may be formed with any other suitable shape(s) that has a continuous edge.

In accordance with another important aspect of the present invention, brake component mounting structures 404, 405 are attached to axle 202 by respective continuous window welds 3CWW2A, 2B, 1 (FIGS. 16-17). In particular, the continuous nature of inner edges 464A, 464B, 484 allow continuous window welds 3CWW2A, 2B, 1, respectively, to attach axle mounting plates 450, 451 to axle 202. More particularly, continuous window welds 3CWW2A, 2B, 1 each begin at a point along the respective inner edge 464A, 464B, 484 of window 430A, 430B, 432; are continuously produced around the respective inner edge; and terminate at the point at which each continuous window weld was initiated. As a result, each continuous window weld 3CWW2A, 2B, 1 has no gaps and lacks separate starting and termination points due to the continuous nature and curvature of inner edges 464A, 464B, 484, completely attaching the entirety of the inner edge to axle tube 206 of axle 202. Thus, continuous window welds 3CWW2A, 2B, 1 minimize and/or eliminate stress risers associated with, and are typically stronger than, prior art line welds. Continuous window welds 3CWW2A, 2B, 1 facilitate the use of thin-wall axle 202, reducing the weight, amount of material, and cost of manufacturing of axle/suspension system 203, thereby enabling the heavy-duty vehicle to carry a greater amount of payload. It is also contemplated that other shapes and/or sizes of axle mounting plates 450, 451 with differently shaped windows 430A, 430B, 432 and inner edges 464A, 464B, 484, respectively, may be used to facilitate the desired continuous window weld 3CWW2A, 2B, 1.

Brake component mounting structure 404 also includes a brake air chamber bracket 352 attached to axle mounting plates 450. Brake component mounting structure 404 may include either brake chamber bracket 252, 352. As described above, brake chamber bracket 352 includes generally concave edges 353. Edges 353 are complementarily-shaped to convex outer surface 457 of axle mounting plate 450. Brake chamber bracket 352 is rigidly attached to mounting plate 450 by welds formed along the interface of edges 353 and axle mounting plate outer surface 457 adjacent windows 430A, B. Because windows 430A, B are arranged proximate to opposing edges 467, 468 of axle mounting plate 450, the windows are accessible when brake air chamber bracket 252, 352 is attached.

Brake component mounting structure 405 includes a cam shaft bracket 282. As described above, cam shaft bracket 282 includes a generally concave edge 288. Edge 288 is complementarily-shaped to outer surface 485 of axle mounting plate 451. Cam shaft bracket 282 is generally disposed laterally of or adjacent to window 332 and attached to mounting plate 451 by welds formed at the interface of edge 288 and axle mounting plate outer surface 485.

During assembly, brake component mounting structures 404, 405 may be fully assembled before installation on thin-wall axle 202. In particular, brake air chamber bracket 352 and cam shaft bracket 282 are attached to respective axle mounting plates 450, 451 by welds formed along the interface of edges 353, 288 and axle mounting plate outer surface 457, 485, respectively. Each brake component mounting structure 404, 405 is positioned on tube 206 of axle 202. More particularly, mounting structures 404, 405 are disposed generally on or adjacent to the front and rear quadrants, or the rear and front quadrants, respectively, of axle tube 206. Each axle mounting plate 450, 451 is placed and/or held against axle tube 206 in position to allow continuous window welds 3CWW2A, 2B, 1 to be formed about the respective inner edge 464A, 464B, 484 of window 430A, 430B, 432. Alternatively, it is contemplated that brake component mounting structures 404, 405 may be assembled after axle mounting plates 450, 451 are separately attached to axle tube 206 by continuous window welds 3CWW2A, 2B, 1, respectively. Thus, once axle mounting plates 450, 451 are affixed to axle 202, brake chamber bracket 352 and cam shaft bracket 282 may be attached to the respective mounting plates as described above.

Thus, brake component mounting structures 404, 405 of the present invention minimize and/or eliminate stress risers, facilitating the use of thin-wall axle 202 and reducing the weight, amount of material, and cost of manufacturing of axle/suspension system 203, thereby enabling the heavy-duty vehicle to carry a greater amount of payload.

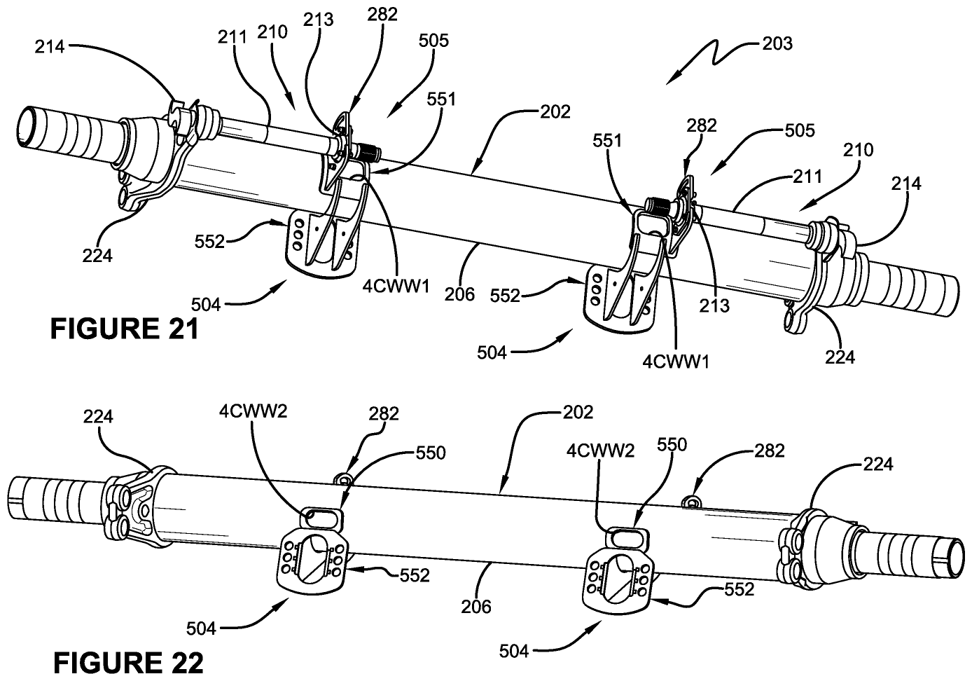

Fourth exemplary embodiment brake component mounting structures 504, 505 of the present invention are shown in FIGS. 21 and 22 incorporated into an axle/suspension system. Brake component mounting structures 504, 505 may be utilized in any axle/suspension system, such as axle/suspension system 203 (partially shown). Brake component mounting structures 504, 505 are similar in construction and arrangement to brake component mounting structures 204, 205 (FIGS. 5-10); brake component mounting structures 304, 305 (FIGS. 11-15); and brake component mounting structures 404, 405 (FIGS. 16-20). As a result, the description below will be primarily directed to the differences between brake component mounting structures 204, 205, 304, 305, 404, 405 and brake component mounting structures 504, 505.

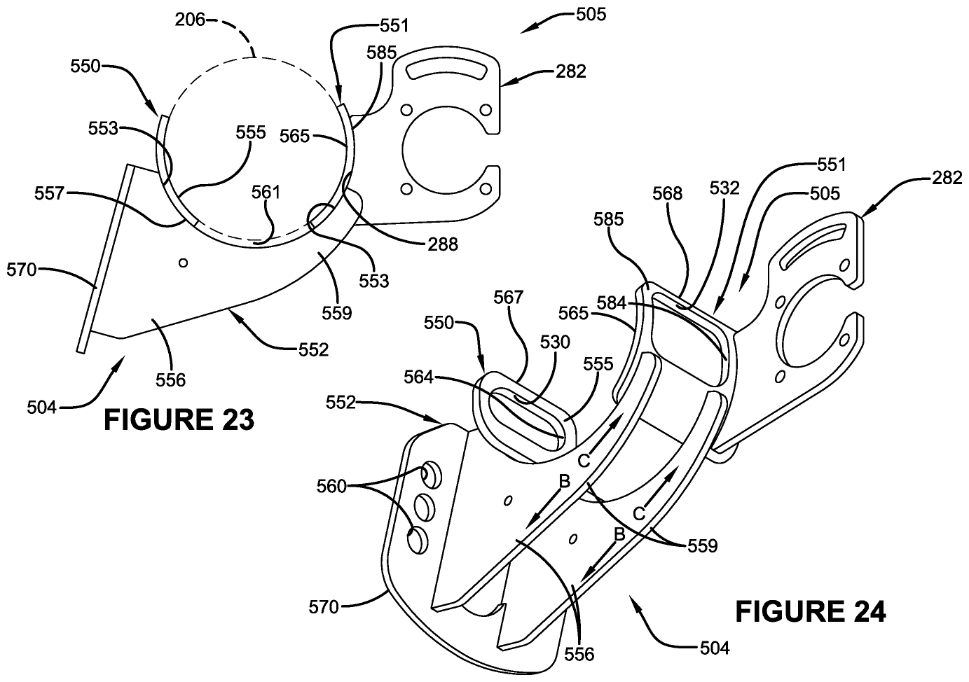

With particular reference to FIGS. 23-24, brake component mounting structures 504, 505 may be formed from any suitable rigid material such as metal or composite, using any suitable method. In particular, brake component mounting structures 504, 505 are formed by bending a single continuous piece of metal having a thickness in the range of from about 0.15 inches to about 0.375 inches, or, more specifically, in the range of from about 0.177 inches to about 0.236 inches, into suitable shapes. However, it is contemplated that any suitable thickness, or even variable thickness, material may be used depending on the expected maximum load mounting structures 504, 505 may encounter during heavy-duty vehicle operation. Alternatively, brake component mounting structures 504, 505 may be formed from multiple pieces and assembled or connected by any suitable means, such as welding.

In accordance with an important aspect of the present invention, brake component mounting structures 504, 505 each include an axle mounting plate 550, 551, respectively. Axle mounting plates 550, 551 are formed with a curvature, such that each axle mounting plate has a respective concave inner surface 555, 565 and a convex outer surface 557, 585. Inner surfaces 555, 565 are complementarily-shaped to the curvature of the outside surface of axle tube 206, thereby facilitating close contact between axle mounting plates 550, 551 and axle 202. Mounting plates 550, 551 each have a respective window 530, 532 formed therein and passing therethrough. Each window 530, 532 is disposed near a respective end 567, 568 of axle mounting plate 550, 551. Each window 530, 532 is defined by a continuous elongated circular, obround, oblong, or oval-shaped inner edge 564, 584, which lack separate starting and termination points. It is also contemplated that windows 530, 532 may have any other suitable shape(s) that has a continuous edge.

In accordance with another important aspect of the present invention, brake component mounting structures 504, 505 are attached to axle 202 by respective continuous window welds 4CWW2, 1 (FIGS. 11-12). In particular, the continuous nature of inner edges 564, 584 allow continuous window weld 4CWW2, 1 to attach axle mounting plates 550, 551 to axle tube 206. More particularly, continuous window welds 4CWW2, 1 each begin at a point along the respective inner edge 564, 584 of window 530, 532; are continuously produced around the respective inner edge; and terminate at the point at which each continuous window weld was initiated. As a result, continuous window weld 4CWW2, 1 has no gaps and lack separate starting and termination points due to the continuous nature and curvature of inner edges 564, 584, completely attaching the entirety of the inner edge to axle tube 206 of axle 202. Thus, continuous window welds 4CWW2, 1 minimize and/or eliminate stress risers associated with, and are typically stronger than, prior art line welds. Continuous window welds 4CWW2, 1 facilitate the use of thin-wall axle tube 206, reducing the weight, amount of material, and cost of manufacturing axle/suspension system 203, thereby enabling the heavy-duty vehicle to carry a greater amount of payload. It is also contemplated that other shapes and/or sizes of axle mounting plates 550, 551 with any differently shaped windows 530, 532 and inner edges 564, 584, respectively, may be used to facilitate the desired continuous window weld 4CWW2, 1.

Brake component mounting structure 504 also includes a brake air chamber bracket 552 attached to and extending between axle mounting plates 550, 551. Brake chamber bracket 552 may be formed from any suitable rigid material, such as metal or composite, by any suitable method, such as bending and have any suitable shape(s), component(s), arrangement(s), and/or feature(s). In particular, brake chamber bracket 552 may be fabricated or, alternatively, formed by casting, forging, or by bending a single continuous sheet of metal.

In accordance with yet another important aspect of the present invention, brake chamber bracket 552 is formed with a pair of spaced-apart parallel sidewalls 556. Each sidewall 556 is integrally formed with a leg, tab, or extension 559. Extensions 559 have a curvature, which is at least partially complementarily-shaped to the outer surface of axle tube 206, and partially encompasses a portion of the axle tube. Extensions 559 may be in contact with axle tube 206 or may form intermittent clearances or a gap 561 between the axle tube and each of the extensions. In particular, during heavy-duty vehicle operation, extensions 559 may undergo deflection, causing or increasing contact between the extensions and axle tube 206. Brake chamber bracket 552 also includes a chamber mounting plate 570, which is attached to and extends perpendicularly from sidewalls 556. Chamber mounting plate 570 is formed with a plurality of openings 560 arranged in a manner suitable for attaching a braking system component, such as a brake air chamber (not shown), to brake chamber bracket 552, as is known.

Each sidewall 556 of brake chamber bracket 552 is formed with a generally concave edge 553 that is complementarily-shaped to outer surface 557 of axle mounting plate 550. Brake chamber bracket 552 is rigidly attached to axle mounting plate 550 by welds formed along the interface of edge 553 and axle mounting plate outer surface 557. In addition, a portion of each extension 559 of brake chamber bracket 552 generally overlaps or contacts axle mounting plate 551. In particular, each extension 559 forms an interface between edge 553 and outer surface 585 of axle mounting plate 551 and may be at least partially attached to the axle mounting plate by welds formed along the interface. As a result, forces generated by components of the braking system and acting on axle mounting plates 550, 551 are distributed or shared, preventing separation of brake component mounting structures 504, 505 from axle 202. In particular, each extension 559 of sidewalls 556 reacts braking forces generated during operation of the heavy-duty vehicle. More particularly, extensions 559 react braking forces generated in direction B by brake air chambers (not shown) and torque or shear forces generated in direction C by cam shafts 211. Extensions 559 share or distribute the forces generated by the braking system across axle mounting plates 550, 551, preventing or minimizing the possibility of separation of the axle mounting plates from axle tube 206 and stabilizing brake component mounting structures 504, 505.

Brake component mounting structure 505 includes cam shaft bracket 282 attached to axle mounting plate 551. As described above, cam shaft bracket 282 includes a generally concave edge 288. Concave edge 288 is complementarily-shaped to outer surface 585 of axle mounting plate 551. Cam shaft bracket 282 is generally disposed laterally of or adjacent to window 532 but may be arranged in any other suitable manner depending on the shape(s) of the window and axle mounting plate 551. Cam shaft bracket 282 is attached to axle mounting plate 551 by welds formed along the interface of edge 288 and outer surface 585 of the axle mounting plate.

During assembly, brake component mounting structures 504, 505 may be fully assembled before installation on thin-wall axle 202. In particular, brake air chamber bracket 552 and cam shaft bracket 282 are attached, as described above, to respective axle mounting plates 550, 551 by welds formed along the interface of edges 553, 288 and axle mounting plate outer surface 557, 585, respectively. Each brake component mounting structure 504, 505 is positioned on tube 206 of axle 202. More particularly, mounting structures 504, 505 are disposed generally on or adjacent to the front and rear quadrants, respectively, of axle tube 206. Each mounting structure 504, 505 is placed and/or held against the axle tube 206 in position to allow respective continuous window welds 4CWW2, 1 to be formed about respective inner edge 564, 584 of window 530, 532. Extensions 559 of brake chamber bracket 552 may then be attached to the mounting plate 551 by appropriate means, such as welding. It is also contemplated that brake component mounting structures 504, 505 may be joined, such that extensions 559 may be attached to mounting plate 551, in a subassembly prior to attaching the brake component mounting structures to axle tube 206.

Alternatively, it is contemplated that brake component mounting structures 504, 505 may be assembled after axle mounting plates 550, 551 are separately attached to axle tube 206 by respective continuous window welds 4CWW2, 1. Thus, once axle mounting plates 550, 551 are affixed to axle tube 206, brake chamber bracket 552 and cam shaft bracket 282 may be attached to the respective mounting plates as described above.

Thus, brake component mounting structures 504, 505 minimize and/or eliminate stress risers and facilitate the use of thin-wall axle tube 206, reducing the weight, amount of material, and cost of manufacturing of axle/suspension system 203, thereby enabling the heavy-duty vehicle to carry a greater amount of payload.

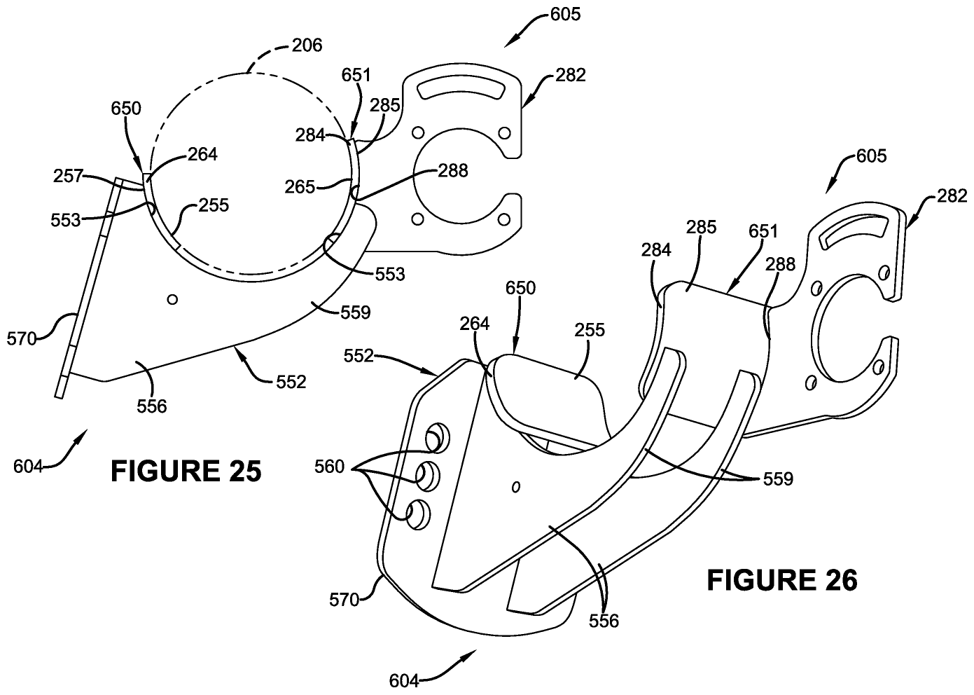

Fifth exemplary embodiment brake component mounting structures 604, 605 of the present invention are shown in FIGS. 25-26. Brake component mounting structures 604, 605 may be utilized with any axle/suspension system, such as axle/suspension system 203 (partially shown). Brake component mounting structures 604, 605 are similar in construction and arrangement to brake component mounting structures 504, 505 (FIGS. 23-24).

It is contemplated that brake component mounting structures 604, 605 may differ from brake component mounting structures 504, 505. In particular, brake component mounting structures 604, 605 include axle mounting plate 650, 651, which are similar to mounting plates 250, 251, respectively. More particularly, brake component mounting structures 604, 605 are attached to axle tube 206 by respective continuous perimeter welds (not shown) formed about outer edges 264, 284 of the respective axle mounting plate 650, 651. Brake component mounting structures 604, 605 also include a brake air chamber bracket 552 and a cam shaft bracket 282, as described above, attached to axle mounting plates 650, 651, respectively. In addition, extensions 559 of brake chamber bracket 552 are attached to axle mounting plate 651 by appropriate means, such as welds.

It is to be understood that brake component mounting structures 204, 205, 304, 305, 404, 405, 504, 505, 604, 605 of the present invention may be altered or rearranged, or certain components omitted, added, or interchanged without affecting the overall concept or operation of the invention. For example, axle mounting plates 250, 251, 350, 351, 450, 451, 550, 551, 650, 651 may include different sizes, thicknesses and/or shapes or may be utilized to mount other components or structures, including other braking system components, other than those shown or described. In particular, it is understood that mounting plates 250, 251, 350, 351, 450, 451, 550, 551, 650, 651 may be employed to mount brake chamber bracket structures other than brake chamber brackets 252, 352, 552 and cam shaft bracket structures other than cam shaft bracket 282. Further, it is contemplated that brake component mounting structures 204, 205, 304, 305, 404, 405, 504, 505, 604, 605 may be constructed of various materials or combinations of materials including metal or other suitable materials known by those skilled in the art. It is also contemplated that windows 330, 332, 430A, 430B, 432, 530, 532 of brake component mounting structures 304, 305, 404, 405, 504, 505, respectively, may have different shapes, sizes, numbers, or arrangements without affecting the overall concept or operation of the invention. It is further contemplated that brake component mounting structures 204, 205, 304, 305, 404, 405, 504, 505, 604, 605 could each be disposed on front or rear quadrants of axle tube 206, or at other locations on or about axle 202, depending on the application. It is yet further contemplated that extensions 559 of brake chamber bracket 552 could be any suitable shape, size, thickness, or orientation.

As described above, it is also to be understood that brake component mounting structures 204, 205, 304, 305, 404, 405, 504, 505, 604, 605 may be employed in conjunction with any type of heavy-duty vehicle axle/suspension system or braking system without affecting the overall concept or operation of the invention. It is also to be understood that brake component mounting structures 204, 205, 304, 305, 404, 405, 504, 505, 604, 605 may be employed in conjunction with any axle, including thick-wall axles and thin-wall axles without affecting the overall concept or operation of the invention.

Accordingly, the brake component mounting structures of the present invention are simplified; provide an effective, safe, inexpensive, and efficient structure and method, which achieve all the enumerated objectives; provide for eliminating difficulties encountered with prior brake component mounting structures; and solve problems and obtain new results in the art.

In the foregoing description, certain terms have been used for brevity, clarity, and understanding; but no unnecessary limitations are to be implied therefrom beyond the requirements of the prior art, because such terms are used for descriptive purposes and are intended to be broadly construed.

The present invention has been described with reference to specific embodiments. It is understood that this description and illustration is by way of example and not by way of limitation. Potential modifications and alterations will occur to others upon a reading and understanding of this disclosure, and it is understood that the invention includes all such modifications, alterations, and equivalents thereof.

Having now described the features, discoveries, and principles of the invention; the manner in which the brake component mounting structures are used and installed; the characteristics of the construction, arrangement, and method steps; and the advantageous, new, and useful results obtained, the new and useful structures, devices, elements, arrangements, process, parts, and combinations are set forth in the appended claims.

What is claimed is:

1. A brake component mounting structure for an axle of a heavy-duty vehicle comprising:
a mounting plate having at least one continuous edge; and
a brake component bracket attached to and extending from said mounting plate;
wherein the mounting plate is attached to said axle by a continuous weld formed along said at least one continuous edge.

2. The brake component mounting structure for an axle of a heavy-duty vehicle of claim 1, said mounting plate having an inner surface formed with a curvature complementary to a curvature of said axle.

3. The brake component mounting structure for an axle of a heavy-duty vehicle of claim 2, said mounting plate having an outer surface, said brake component bracket being attached to said outer surface.

4. The brake component mounting structure for an axle of a heavy-duty vehicle of claim 1, said brake component bracket supporting a component of a heavy-duty vehicle braking system.

5. The brake component mounting structure for an axle of a heavy-duty vehicle of claim 1, said mounting plate and said brake component bracket being formed by at least one process chosen from the group consisting of fabrication, forging, and casting.

6. The brake component mounting structure for an axle of a heavy-duty vehicle of claim 1, said mounting plate and said brake component bracket being formed from sheet metal by bending.

7. The brake component mounting structure for an axle of a heavy-duty vehicle of claim 6, said mounting plate having a thickness in the range of from about 0.15 inches to about 0.375 inches.

8. The brake component mounting structure for an axle of a heavy-duty vehicle of claim 7, said mounting plate having a thickness in the range of from about 0.177 inches to about 0.236 inches.

9. The brake component mounting structure for an axle of a heavy-duty vehicle of claim 1, said mounting plate being attached to said axle in a selected one of a front or a rear quadrant of the axle.

10. The brake component mounting structure for an axle of a heavy-duty vehicle of claim 1, said at least one continuous edge being formed about an outer perimeter of said mounting plate, said continuous weld forming a seal about the at least one continuous edge to prevent infiltration of moisture and oxidizing agents between said mounting plate and said axle.

11. The brake component mounting structure for an axle of a heavy-duty vehicle of claim 1, said mounting plate being formed with at least one window, said at least one continuous edge being formed about an inner perimeter of said at least one window.

12. The brake component mounting structure for an axle of a heavy-duty vehicle of claim 1, said mounting plate being formed with a pair of windows, said at least one continuous edge being formed about an inner perimeter of each one of said pair of windows, said brake component bracket being disposed between the pair of windows.

13. A brake component mounting structure for an axle of a heavy-duty vehicle comprising:
a first mounting plate having at least one continuous edge;
a second mounting plate spaced a circumferential distance about said axle from said first mounting plate and having at least one continuous edge; and
a brake component bracket attached to and extending between the first mounting plate and said second mounting plate;
wherein said first and second mounting plates are each attached to the axle by at least one continuous weld at an interface between said axle and said at least one continuous edge.

14. The brake component mounting structure for an axle of a heavy-duty vehicle of claim 13, said first and second mounting plates having an inner surface formed with a curvature complementary to a curvature of said axle.

15. The brake component mounting structure for an axle of a heavy-duty vehicle of claim 14, said first and second mounting plates having an outer surface, said brake component bracket being attached to said outer surface.

16. The brake component mounting structure for an axle of a heavy-duty vehicle of claim 13, said first and second mounting plates being attached to said axle in a front or a rear quadrant of the axle.

17. The brake component mounting structure for an axle of a heavy-duty vehicle of claim 13, said at least one continuous edge being formed about an outer perimeter of at least one of said first mounting plate and said second mounting plate, said continuous weld forming a seal about the at least one continuous edge to prevent infiltration of moisture and oxidizing agents between the first and second mounting plates and said axle.

18. The brake component mounting structure for an axle of a heavy-duty vehicle of claim 13, at least one of said first and second mounting plates being formed with at least one window, said at least one continuous edge being formed about an inner perimeter of said at least one window.

19. The brake component mounting structure for an axle of a heavy-duty vehicle of claim 13, said brake component bracket having a portion at least partially disposed about and surrounding said axle.

20. The brake component mounting structure for an axle of a heavy-duty vehicle of claim 19, said portion of said brake component bracket being attached to said second mounting plate.

21. The brake component mounting structure for an axle of a heavy-duty vehicle of claim 13, said first and second mounting plates and said brake component mounting bracket being formed by at least one process chosen from the group consisting of fabrication, forging, and casting.

22. The brake component mounting structure for an axle of a heavy-duty vehicle of claim 13, said first and second mounting plates and said brake component mounting bracket being formed from sheet metal by bending.

23. The brake component mounting structure for an axle of a heavy-duty vehicle of claim 22, said first and second mounting plates having a thickness in the range of from about 0.15 inches to about 0.375 inches.

24. The brake component mounting structure for an axle of a heavy-duty vehicle of claim 23, said first and second mounting plates having a thickness in the range of from about 0.177 inches to about 0.236 inches.

25. The brake component mounting structure for an axle of a heavy-duty vehicle of claim 14, said brake component bracket supporting a component of a heavy-duty vehicle braking system.
